(19) United States
(12) Patent Application Publication
(10) Pub. No.: US 2009/0234998 A1
(43) Pub. Date: Sep. 17, 2009

(54) CONNECTION SYSTEM

(75) Inventor: HENG-CHEN KUO, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/121,814

(22) Filed: May 16, 2008

(30) Foreign Application Priority Data
Mar. 12, 2008 (CN) 200810300546.3

(51) Int. Cl. G06F 13/18

(52) U.S. Cl. 710/110

(57) ABSTRACT

An exemplary connection system includes an I2C bus and two or more devices. Each device has a dip switch, a MCU, and a bus controller. The dip switch is configured for assigning an address to the device. The MCU is connected to the dip switch and configured for detecting whether the device is a master or a slave device according to the address assigned by the dip switch. The bus controller is connected to the MCU and the I2C bus, and is configured for converting a data transmission mode between the MCU and the bus controller. In this system, at least one device is a master device and at least one device is a slave device, the master device is capable of monitoring the slave device, and the slave device is capable of transmitting information to the master device.

### BACKGROUND

1. Field of the Invention

The present invention relates to a connection system, and particularly to a connection system for connecting a plurality of electronic devices.

2. Description of Related Art

In a conventional connection system for connecting a plurality of electronic devices, serial interfaces are used for data communications between a master device and a plurality of slave devices.

However, this conventional connection system only allows the master device to connect with one of the slave devices at any given time via the serial interfaces thereof. If the master device needs to access another slave device at the same time, the user must connect a serial interface of the master device to a serial interface of another slave device again, which can be very inconvenient.

What is desired, therefore, is to provide a connection system which can simultaneously connect a plurality of slave devices.

### SUMMARY

An exemplary connection system includes an inter-integrated circuit (I2C) bus and two or more devices. Each device has a dip switch, a micro controller unit (MCU), and a bus controller. The dip switch is configured for assigning an address to the device. The MCU is connected to the dip switch and configured for detecting whether the device is a master or a slave device according to the address assigned by the dip switch. The bus controller is connected to the MCU and the I2C bus, and is configured for converting a data transmission mode between the MCU and the bus controller. In this connection system, at least one device is a master device and at least one device is a slave device, the master device is capable of monitoring the slave device, the slave device is capable of transmitting information to the master device, and all of the two or more devices are capable of serving as the master device and the slave device.

Other advantages and novel features of the present invention will become more apparent from the following detailed description of an embodiment when taken in conjunction with the accompanying drawings, in which:

### BRIEF DESCRIPTION OF THE DRAWINGS

FIG. 1 is a block diagram of a connection system in accordance with an embodiment of the present invention, the connection system including a master device and a plurality of slave devices; and

FIG. 2 is detail block diagram of the master device of the connection system of FIG. 1.

### DETAILED DESCRIPTION

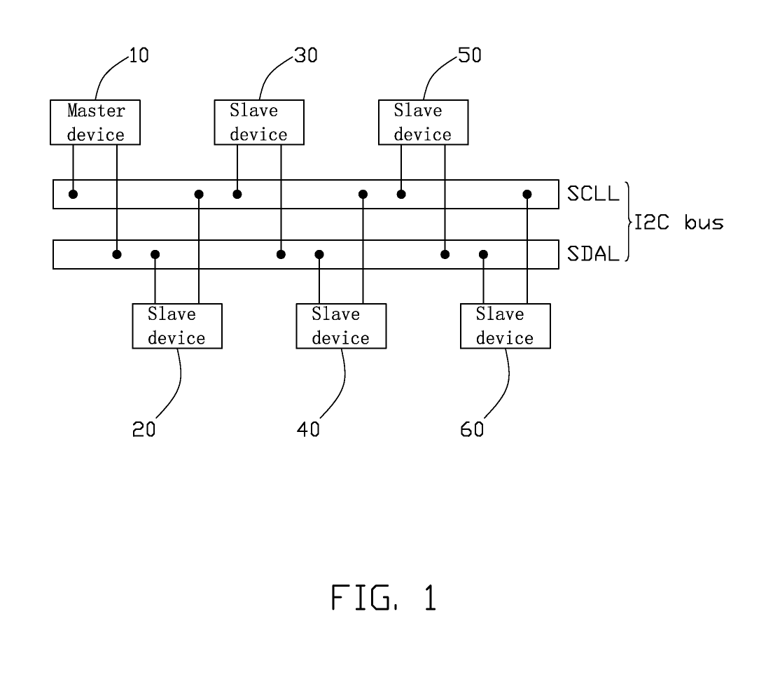

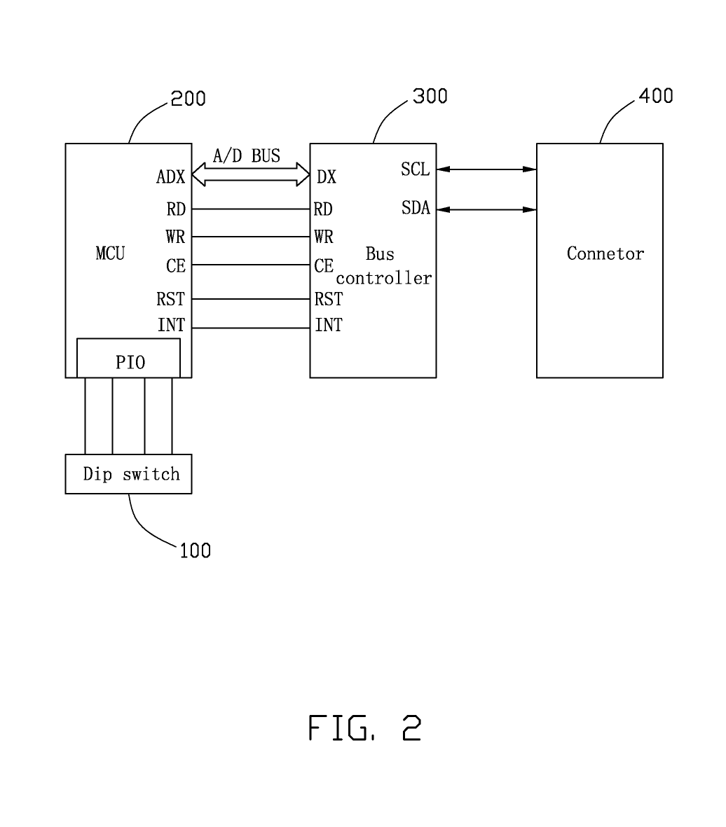

Referring to FIG. 1 and FIG. 2, a connection system in accordance with an embodiment of the present invention includes an inter-integrated circuit (I2C) bus, a master device 10, such as a server, and five slave devices 20-60, such as uninterrupted power supply (UPS) systems. The master device 10 and slave devices 20-60 all have a similar structure. The master device 10 includes a dip switch 100, a micro controller unit (MCU) 200, a bus controller 300, and a connector 400. In other embodiments, the number of slave devices can be varied according to user-specific needs.

The MCU 200 includes a plurality of input/output (I/O) ports PIO, a plurality of address/data pins ADX, and five control pins RD, WR, CE, RST, INT. The bus controller 300 includes a plurality of address/data pins DX, five control pins RD, WR, CE, RST, INT, a serial clock pin SCL, and a serial data pin SDA. The dip switch 100 is connected to the I/O ports PIO of the MCU 200 and is configured for assigning an address to the master device 10. The address/data pins ADX of the MCU 200 are connected to the address/data pins DX of the bus controller 300, and the control pins RD, WR, CE, RST, INT of the MCU 200 are respectively connected to the control pins RD, WR, CE, RST, INT of the bus controller 300, configured for transmitting control signals between the MCU 200 and the bus controller 300. The serial clock pin SCL and the serial data pin SDA of the bus controller 300 are connected to the connector 400.

The master device 10 is connected to the slave devices 20-60 via the I2C bus including a serial clock line SCLL, and a serial data line SDAL. The serial clock pin SCL and the serial data pin SDA of the bus controller 300 of the master device 10 and the slave devices 20-60 are respectively connected to the serial clock line SCLL and the serial data line SDAL of the I2C bus via the connector 400.

The dip switch 100 employs four buttons to assign an address to the device before the connection system is turned on. The address of the master device 10 can be “0000”, and the slave devices 20-60 can be “0001”, “0010”, “0011”, “0100”, and “0101” respectively, each device having its own unique address. When the connection system is turned on, the MCU 200 in each device reads the address set by the corresponding dip switch 100, and writes the address into an address register (not shown) of the bus controller 300 via an address/data bus A/D BUS and the control pins RD, WR, CE, RST, INT. The MCU 200 detects whether the device is a master device or a slave device according to the address, wherein “0000” is the default address of the master device.

If the MCU 200 of the device detects it is the master device 10, the master device 10 will control the I2C bus. The MCU 200 of the master device 10 monitors the slave devices 20-60 connected to the I2C bus in sequence, according to the addresses assigned by the corresponding dip switch 100. The bus controller 300 of the master device 10 sends a command to the bus controllers 300 of the slave devices 20-60. Once receiving the command, the bus controllers 300 of the slave devices 20-60 send interrupt instructions to their corresponding MCUs 200 respectively, the MCUs 200 of the slave devices 20-60 transmit device information of the corresponding slave devices to the master device 10. After receiving the device information of the slave devices 20-60, the bus controllers 300 of the master device 10 sends an interrupt instruction to its MCU 200, then the MCU 200 of the master device 10 fetches the device information from its bus controllers 300 to provide the working state of the slave devices 20-60 to a user.

If the MCU 200 of the device detects it is slave device 20, 30, 40, 50, or 60, the bus controller 300 of the slave device 20, 30, 40, 50 or 60 will wait for the command sent by the master device 10. Once receiving the command, the slave device 20, 30, 40, 50, or 60 will process the steps mentioned above.

In each of the master and slave devices, when the MCU 200 communicates with the bus controller 300, the bus controller 300 converts signals transmitted from the MCU 200 to the bus controller 300 from a parallel data transmission mode to a serial data transmission mode. Otherwise the bus controller 300 converts signals transmitted from the bus controller 300 to the MCU 200 from the serial data transmission mode to the parallel data transmission mode. In this embodiment, the bus controller 300 is an I2C bus controller, and PAC9564 is selected as the bus controller 300. However, other bus controllers having the similar functions can also be used.

In the above-described connection system, the dip switch 100 assigns an unique address for each device, and all the devices are connected via a common I2C bus, so the connection system can allow all devices to turn on at the same time without address conflicts.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connection system comprising:
an inter-integrated circuit (I2C) bus; and
two or more devices, each of the devices comprising:
a dip switch configured for assigning an address to the device;
a micro controller unit (MCU) connected to the dip switch and configured for detecting whether the device is a master device or a slave device according to the address assigned by the dip switch; and
a bus controller connected to the MCU and the I2C bus, configured for converting
a data transmission mode between the MCU and the bus controller;
wherein at least one device is a master device and at least one device is a slave device;
the master device is capable of monitoring the slave device, and the slave device is capable of transmitting information to the master device; and
all of the two or more devices are capable of serving as the master device and the slave device;

2. The connection system as claimed in claim 1, wherein each bus controller comprises a serial data pin and a serial clock pin;
the I2C bus comprises a serial data line and a serial clock line, each of the serial data pins and the serial clock pins is connected to the serial data line and the serial clock line of the I2C bus respectively via a connector.

3. The connection system as claimed in claim 1, wherein the MCU and the bus controller each comprises a plurality of address/data pins and five control pins, the corresponding address/data pins and control pins of the MCU and the bus controller are connected respectively.

4. The connection system as claimed in claim 1, wherein the MCU further comprises a plurality of input/output ports connected to the dip switch.

5. The connection system as claimed in claim 1, wherein the bus controller is capable of converting signals transmitted from the MCU to the bus controller from a parallel data transmission mode to a serial data transmission mode.

6. The connection system as claimed in claim 1, wherein the bus controller is capable of converting signals transmitted from the bus controller to the MCU from the serial data transmission mode to the parallel data transmission mode.

7. The connection system as claimed in claim 1, wherein the bus controller is an I2C bus controller.
